(19) United States
(12) Patent Application Publication
(10) Pub. No.: US 2013/0156074 A1
(43) Pub. Date: Jun. 20, 2013

(54) WIDEBAND RF FRONT-END

(71) Applicants: Hans Wang, Mountain View, CA (US); Binglei Zhang, San Jose, CA (US); Tao Li, Campbell, CA (US); Shih Hsiung Mo, San Jose, CA (US)

(72) Inventors: Hans Wang, Mountain View, CA (US); Binglei Zhang, San Jose, CA (US); Tao Li, Campbell, CA (US); Shih Hsiung Mo, San Jose, CA (US)

(73) Assignee: AVIACOMM INC., Santa Clara, CA (US)

(21) Appl. No.: 13/325,340

(22) Filed: Dec. 14, 2011

(51) Int. Cl. H04B 1/38; H04L 27/04; H04L 27/06

(52) U.S. Cl. 375/219; 375/340; 375/295

(57) ABSTRACT

One embodiment of the present invention includes a transceiver for wireless communication. The transceiver includes an antenna, a transmitter, which comprises a tunable matching network and a modulator, and a receiver, which comprises a programmable band-pass filter (BPF) and a demodulator.

### BACKGROUND

1. Field

The present disclosure relates generally to the RF front-end of a wireless communication system. More specifically, the present disclosure relates to a wideband RF front-end.

2. Related Art

Traditional wireless communication systems are usually designed for a specific standard, such as GSM (Global System for Mobile Communications) or Wideband Code Division Multiple Access (W-CDMA), each requiring different carrier frequencies. For example, the carrier frequency of the GSM signals varies from 800 MHz to 1 GHz, while the carrier frequency of the W-CDMA signals varies between 2-3 GHz. Current demand for the convergence of wireless services, in which users can access different standards from the same wireless device, is driving the development of multi-standard and multi-band transceivers, which are capable of transmitting/receiving radio signals in the entire wireless communication spectrum (from 300 MHz to 3 GHz).

To meet multi-standard and multi-band requirements, the RF front-end (the circuitry between the antenna and the first intermediate frequency (IF) stage) needs to operate over a frequency range covering the entire wireless communication spectrum. A typical RF front-end of a multi-band/multi-standard wireless transceiver includes a matching network for impedance matching, a set of band-pass filters (BPFs) for channel selection, an off-chip power amplifier (PA), and an RF integrated-circuit (IC) chip for modulation/demodulation. When wideband PA and wideband RF IC are implemented, the channel-selection mechanism becomes the limiting factor for the size of the device. For example, four BPFs are required to form the RF front-end of a quad-band cell phone, thus resulting in a device that is large enough to accommodate four BPFs.

Moreover, a recent decision of the Federal Communications Commission (FCC) has allowed unlicensed broadcasting devices access to “white spaces” in the television spectrum, prompting the development of the “WhiteFi” technology and white-spaces devices. Unlike traditional WiFi, which operates most commonly at 2.4 GHz and 5.0 GHz, white-spaces devices operate over 30 separate 6 MHz TV channels (freed after the conversion to digital TV). The large number of white space channels intensifies the channel selection problem for the white-spaces devices.

### SUMMARY

One embodiment of the present invention provides a receiver for wireless communication. The receiver includes an antenna, a tunable demodulator, and a programmable band-pass filter (BPF) situated between the antenna and the tunable demodulator.

In a variation on this embodiment, a central frequency of the programmable BPF can be tuned in a range from 300 MHz to 3.6 GHz.

In a further variation, the central frequency of the programmable BPF can be tuned dynamically.

In a variation on this embodiment, the programmable BPF includes a tunable low-pass filter (LPF) and a tunable high-pass filter (HPF).

In a variation on this embodiment, the tunable demodulator is a quadrature demodulator.

In a variation on this embodiment, the tunable demodulator has a tuning range between 300 MHz and 3.6 GHz.

In a further embodiment, the tunable demodulator includes a fraction-N synthesizer.

In a variation on this embodiment, the receiver further includes a wideband amplifier situated between the programmable BPF and the tunable demodulator.

One embodiment of the present invention provides a transmitter for wireless communication. The transmitter includes an antenna, a tunable modulator, and a tunable matching network situated between the antenna and the tunable modulator.

In a variation on this embodiment, the tunable matching network is configured to match an impedance of the antenna over a frequency range from 300 MHz to 3.6 GHz.

In a variation on this embodiment, the tunable modulator is a quadrature modulator.

In a variation on this embodiment, the tunable modulator has a tuning range between 300 MHz and 3.6 GHz.

In a variation on this embodiment, the transmitter further includes a wideband amplifier situated between the tunable modulator and the tunable matching network.

One embodiment of the present invention includes a transceiver for wireless communication. The transceiver includes an antenna, a transmitter, which comprises a tunable matching network and a modulator, and a receiver, which comprises a programmable band-pass filter (BPF) and a demodulator.

In a variation on this embodiment, a central frequency of the programmable BPF can be tuned in a range from 300 MHz to 3.6 GHz.

In a variation on this embodiment, the programmable BPF includes a tunable low-pass filter (LPF) and a tunable high-pass filter (HPF).

In a variation on this embodiment, the tunable matching network is configured to match an impedance of the antenna over a frequency range from 300 MHz to 3.6 GHz.

### BRIEF DESCRIPTION OF THE FIGURES

FIG. 1 presents a diagram illustrating the architecture of a wideband wireless receiver using a group of band-pass filters (BPFs).

FIG. 2 presents a diagram illustrating the architecture of a wideband wireless receiver using a single programmable BPF, in accordance with an embodiment of the present invention.

FIG. 3 presents a diagram illustrating the architecture of a wideband wireless transmitter using a group of matching networks.

FIG. 4 presents a diagram illustrating the architecture of a wideband wireless transmitter, in accordance with an embodiment of the present invention.

FIG. 5 presents a diagram illustrating the architecture of a wideband wireless transceiver, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide a solution for a wideband RF front-end. In one embodiment, the wideband RF front-end includes a programmable band-pass filter (BPF) and a tunable matching network.

### Wideband RF Receiver Front-End

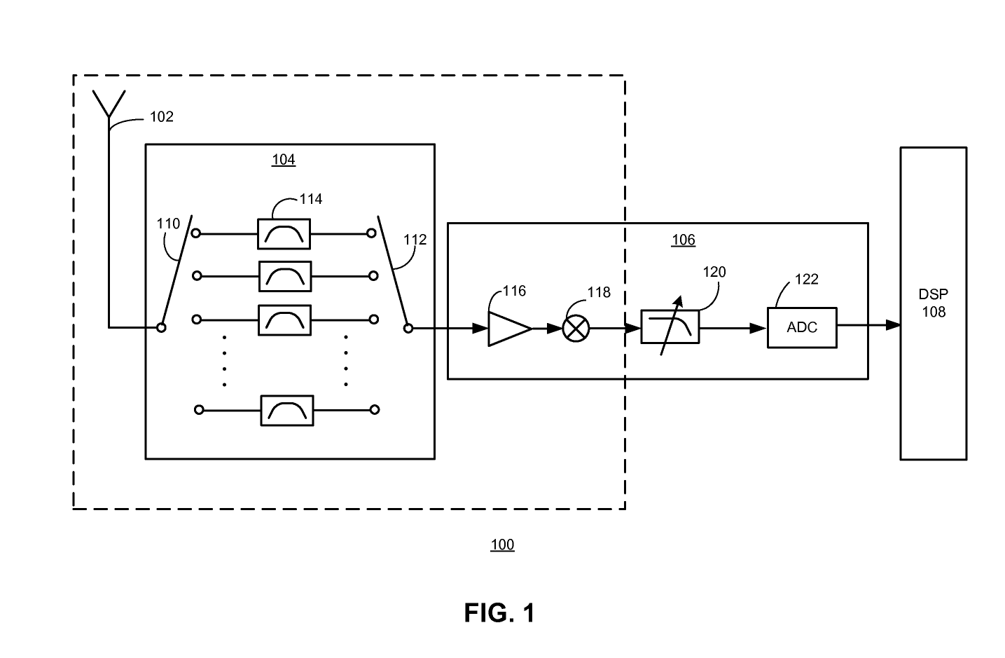

FIG. 1 presents a diagram illustrating the architecture of a wideband wireless receiver using a group of BPFs. In FIG. 1, receiver 100 includes an antenna 102, a switch chip 104, an RF IC chip 106, and a baseband digital signal processor (DSP) 108.

Switch chip 104 includes a 1×n switch 110, a number of BPFs (such as BPF 114), and an n×1 switch 112. RF IC chip 106 includes a wideband amplifier 116, a tunable demodulator 118, a tunable low-pass filter (LPF) 120, and an ADC 122. Note that switches 110 and 112 together with BPFs of different passing bands ensure that RF signals of the different frequency bands are fed to wideband amplifier 116 via a single input.

During operation, depending on which standard is currently active, and thus the frequency band of the desired RF signal, single-pole multi-throw (SPMT) switch 110 switches the received RF signal to a corresponding BPF, whose passing band corresponds to the frequency band of the desired RF signal. The outputs of all BPFs are coupled to ultra-wideband amplifier 116 via SPMT switch 112. Note that the switch position of switch 110 corresponds to that of switch 112, thus ensuring that the correct filter output is sent to wideband amplifier 116 for amplification. For example, if receiver 100 is configured to receive signals at a particular TV channel, switches 110 and 112 ensure that the received RF signals are filtered by a BPF having a passing band that corresponds to the particular TV channel.

Amplifier 116 is a wideband amplifier capable of amplifying RF signals over a wide frequency range. Demodulator 118 subsequently down-converts the amplified RF signal to an IF signal or to a baseband signal. In one embodiment, demodulator 118 is a quadrature demodulator. In one embodiment, the local oscillator (not shown in FIG. 1) of demodulator 118 is tuned to the same frequency as that of the RF carrier corresponding to the TV channel; hence, the RF signal is directly converted to a baseband signal. Tunable LPF 120 rejects the signal at the summation frequency and sends the baseband signal to ADC 122, which converts the analog signal to the digital domain before sending it to a baseband DSP 108 for further processing.

In order to receive signals across tens of TV channels that are freed after the conversion to digital TV, receiver 100 needs to include tens of BPFs, which leads to increased device size. To overcome this problem, embodiments of the present invention provide a receiver that implements a single programmable BPF between the RF front-end and the antenna.

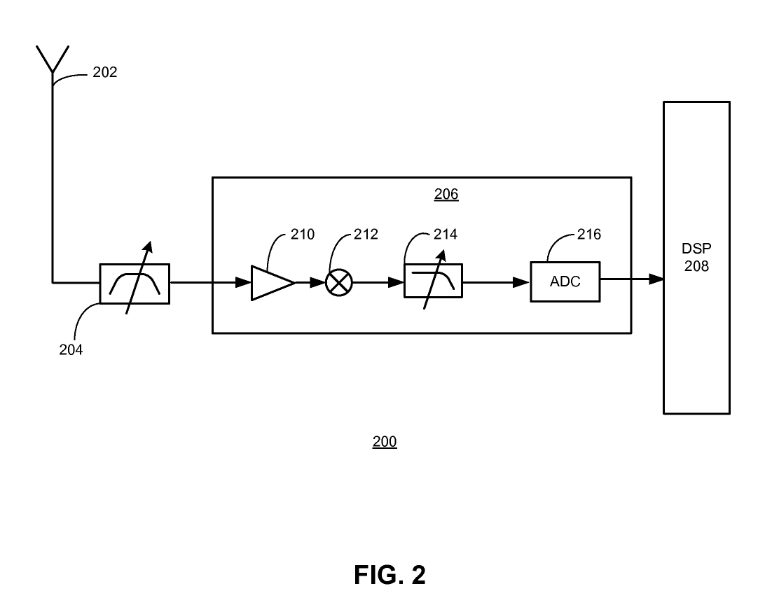

FIG. 2 presents a diagram illustrating the architecture of a wideband wireless receiver, in accordance with an embodiment of the present invention. In FIG. 2, receiver 200 includes an antenna 202, a programmable BPF 204, an RF IC chip 206, and a baseband digital signal processor (DSP) 208.

During operation, programmable BPF 204 is configured to select RF signals at the desired channel before sending the selected signals to RF IC chip 206 for demodulation and down conversion. The central frequency of programmable BPF 204 can be programmed based on the carrier frequency of the desired RF signal. By using a single programmable BPF for channel selection, embodiments of the present invention significantly reduce the size of the device. In one embodiment, programmable BPF 204 is programmed before receiver 200 is put in use. Depending on the current standard, the central frequency of programmable BPF 204 can be tuned to the desired value. In one embodiment, the central frequency of programmable BPF 204 can be tuned dynamically, enabling receiver 200 to switch channels when needed. In a further embodiment, the central frequency of programmable BPF 204 is tunable over the entire wireless communication spectrum (from 300 MHz to 3.6 GHz).

Various techniques can be used to fabricate programmable BPF 204. In one embodiment, programmable BPF 204 is formed using a tunable LPF and a tunable HPF. Hence, by tuning the cutoff frequencies of the LPF and the HPF, one can tune the central frequency and the bandwidth of programmable BPF 204.

RF IC chip 206 includes a wideband amplifier 210, a tunable demodulator 212, a tunable low-pass filter (LPF) 214, and an ADC 216. In one embodiment, tunable demodulator 212 is a quadrature demodulator capable of demodulating received RF signals over a wide frequency range (from 300 MHz to 3.6 GHz). In a further embodiment, tunable demodulator 212 includes a fraction-N synthesizer that enables the output of the local oscillator to cover a wide frequency range (from 300 MHz to 3.6 GHz).

### Wideband RF Transmitter Front-End

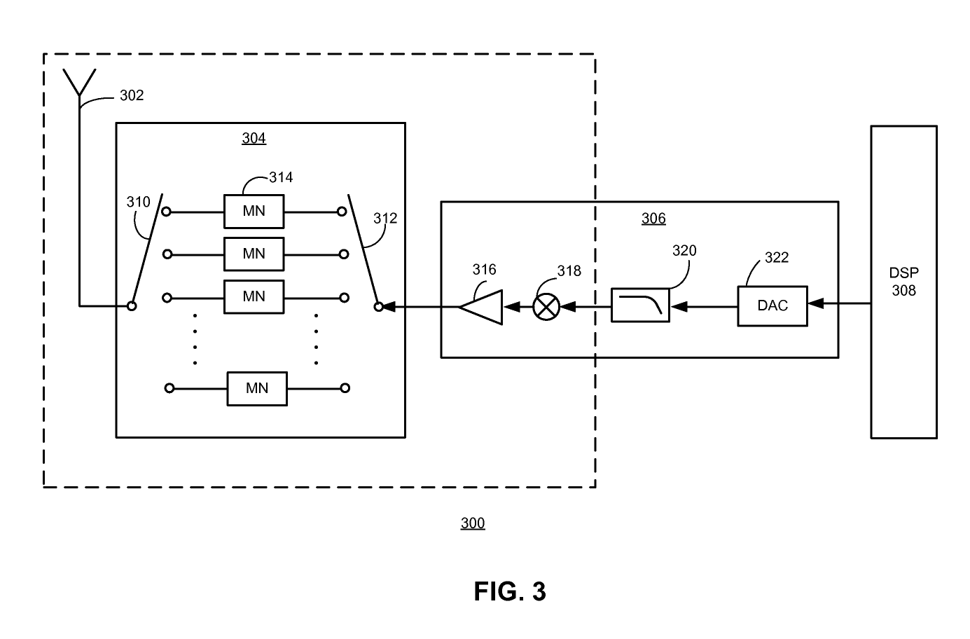

A matching network can be used to match the impedance of a transmitter to the impedance of an antenna. Because the impedance of the transmitter varies as a function of carrier frequency, different matching networks are needed for different frequency bands. For example, the transmitter may use one matching network for GSM transmission and a different matching network for W-CDMA transmission. Hence, a transmitter needs to include multiple matching networks in order to operate over a broad spectrum. FIG. 3 presents a diagram illustrating the architecture of a wideband wireless transmitter using a group of matching networks. In FIG. 3, transmitter 300 includes an antenna 302, a switch chip 304, an RF IC chip 306, and a baseband digital signal processor (DSP) 308.

Switch chip 304 includes an n×1 switch 310, a number of matching networks (such as matching network 314), and a 1×n switch 312. RF IC chip 306 includes a wideband amplifier 316, a tunable modulator 318, an LPF 320, and a DAC 322. Note that switches 310 and 312 together with matching networks of different frequency bands ensure that the output impedance of amplifier 316 is always matched to the impedance of antenna 302 regardless of the carrier frequency of the transmitted RF signal. In one embodiment, a separate power amplifier (PA) is used for each frequency band; and a corresponding matching network matches the impedance of that PA with the impedance of the antenna.

During operation, baseband signals provided by baseband DSP 308 are converted from the digital domain to the analog domain by DAC 322. LPF 320 filters out any out-of-band noise. Depending on the currently active standard or mode of operation, tunable modulator 318 modulates the baseband signal to a particular carrier frequency. Wideband amplifier 316 amplifies the modulated RF signal. Switches 312 and 310 select a matching network corresponding to the RF frequency, and send the RF signal to antenna 302 for transmission.

In order to transmit signals across tens of TV channels that are freed after the conversion to digital TV, transmitter 300 needs to include tens of matching networks, which leads to increased device size. To overcome this problem, embodiments of the present invention provide a transmitter that implements a single tunable matching network situated between the RF transmitter front-end and the antenna.

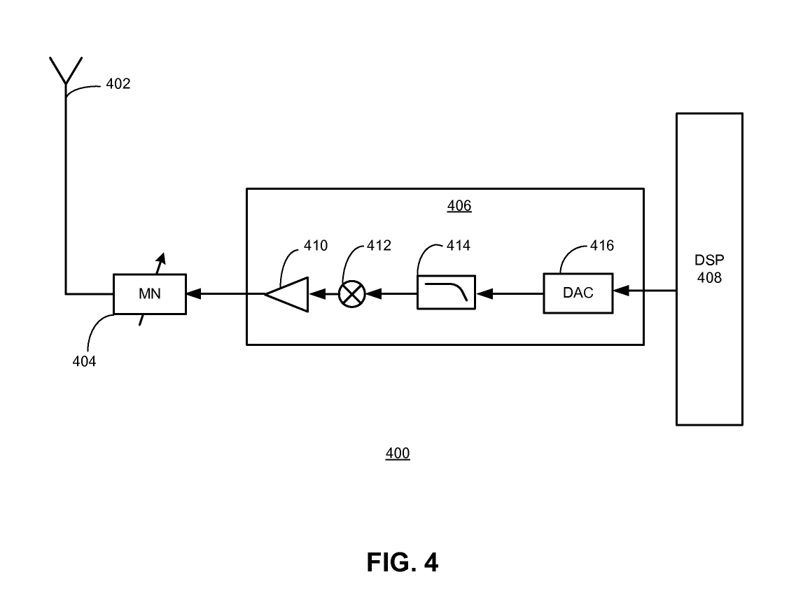

FIG. 4 presents a diagram illustrating the architecture of a wideband wireless transmitter, in accordance with an embodiment of the present invention. In FIG. 4, transmitter 400 includes an antenna 402, a tunable matching network 404, an RF IC chip 406, and a baseband digital signal processor (DSP) 408. RF IC chip 406 includes a DAC 418, an LPF 414, a tunable modulator 412, and a wideband amplifier 410. In one embodiment, tunable modulator 412 is a quadrature modulator capable of modulating RF signals over a wide frequency range (from 300 MHz to 3.6 GHz).

During operation, depending on the carrier frequency of the transmitted RF signal, tunable matching network 404 is tuned to make sure that the impedance of amplifier 410 matches the impedance of antenna 402. By using a single tunable matching network for impedance matching, embodiments of the present invention significantly reduce the size of the device.

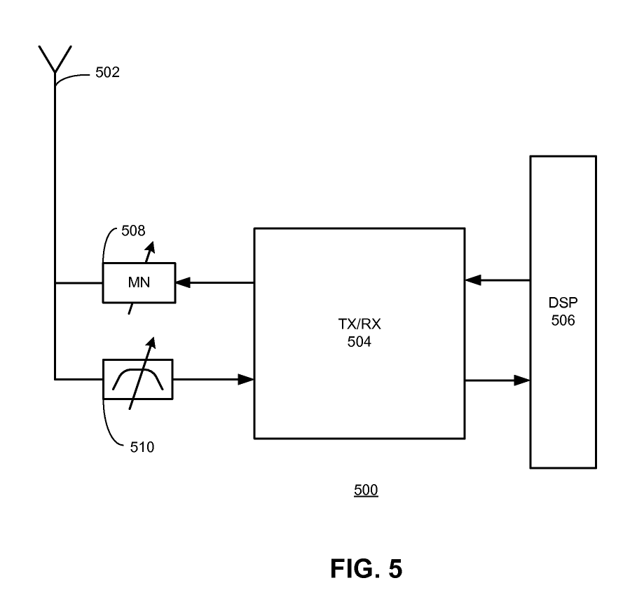

It is possible to integrate the RF IC of the transmitter and the RF IC of the receiver onto a single RF transceiver IC chip, which performs the RF modulation and demodulation. By coupling the tunable matching network and the programmable BPF to the RF transceiver IC chip, one can obtain a wideband RF wireless transceiver. FIG. 5 presents a diagram illustrating the architecture of a wideband wireless transceiver, in accordance with an embodiment of the present invention. In FIG. 5, transceiver 500 includes an antenna 502, an RF IC transceiver chip 504, a DSP 506, a tunable matching network 508, and a programmable BPF 510. In one embodiment, transceiver 500 is configured to operate over the TV white space spectrum.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A receiver for wireless communication, comprising:
an antenna;
a tunable demodulator; and
a programmable band-pass filter (BPF) situated between the antenna and the tunable demodulator.

2. The receiver of claim 1, wherein a central frequency of the programmable BPF can be tuned in a range from 300 MHz to 3.6 GHz.

3. The receiver of claim 2, wherein the central frequency of the programmable BPF can be tuned dynamically.

4. The receiver of claim 1, wherein the programmable BPF includes a tunable low-pass filter (LPF) and a tunable high-pass filter (HPF).

5. The receiver of claim 1, wherein the tunable demodulator is a quadrature demodulator.

6. The receiver of claim 1, wherein the tunable demodulator has a tuning range between 300 MHz and 3.6 GHz.

7. The receiver of claim 6, wherein the tunable demodulator includes a fraction-N synthesizer.

8. The receiver of claim 1, further comprising a wideband amplifier situated between the programmable BPF and the tunable demodulator.

9. A transmitter for wireless communication, comprising:
an antenna;
a tunable modulator; and
a tunable matching network situated between the antenna and the tunable modulator.

10. The transmitter of claim 9, wherein the tunable matching network is configured to match an impedance of the antenna over a frequency range from 300 MHz to 3.6 GHz.

11. The transmitter of claim 9, wherein the tunable modulator is a quadrature modulator.

12. The transmitter of claim 9, wherein the tunable modulator has a tuning range between 300 MHz and 3.6 GHz.

13. The transmitter of claim 9, further comprising a wideband amplifier situated between the tunable modulator and the tunable matching network.

14. A transceiver for wireless communication, comprising:
an antenna;
a transmitter, which comprises a tunable matching network and a modulator; and
a receiver, which comprises a programmable band-pass filter (BPF) and a demodulator.

15. The transceiver of claim 14, wherein a central frequency of the programmable BPF can be tuned in a range from 300 MHz to 3.6 GHz.

16. The transceiver of claim 14, wherein the programmable BPF includes a tunable low-pass filter (LPF) and a tunable high-pass filter (HPF).

17. The transceiver of claim 14, wherein the tunable matching network is configured to match an impedance of the antenna over a frequency range from 300 MHz to 3.6 GHz.
